(19) United States
(12) Patent Application Publication
(10) Pub. No.: US 2013/0046732 A1
(43) Pub. Date: Feb. 21, 2013

(54) DATA SYNCHRONIZATION MANAGEMENT METHODS AND SYSTEMS

(71) Applicants: Hsin-Ti CHUEH, Taoyuan County (TW); Ssu-Po CHIN, Taoyuan County (TW)

(72) Inventors: Hsin-Ti CHUEH, Taoyuan County (TW); Ssu-Po CHIN, Taoyuan County (TW)

(21) Appl. No.: 13/548,432

(22) Filed: Jul. 13, 2012

Related U.S. Application Data
(60) Provisional application No. 61/524,690, filed on Aug. 17, 2011.

(51) Int. Cl. G06F 17/30

(52) U.S. Cl. 707/634; 707/E17.005

(57) ABSTRACT

Data synchronization management methods and systems are provided. First, pluralities of predetermined sync conditions are set according to time interval information and user behavior information, wherein each of the predetermined sync conditions has a corresponding setting value of update frequency. Then, it is determined whether one of the predetermined sync conditions has been satisfied or a change in the predetermined sync conditions has been detected. In response to one of the predetermined sync conditions being satisfied or a change in the predetermined sync conditions being detected, a data sync procedure is performed with a server to update data from the server based on an update frequency, such that the update frequency of the data sync procedure is dynamically adjusted according to the predetermined sync conditions.

### CROSS REFERENCE TO RELATED APPLICATIONS

This Application claims priority of U.S. Provisional Application No. 61/524,690, filed on Aug. 17, 2011, and the entirety of which is incorporated by reference herein.

### BACKGROUND OF THE INVENTION

1. Field of the Invention

The disclosure relates generally to data synchronization management methods and systems, and, more particularly to data synchronization management methods and systems that provide management for dynamically adjustment of update frequency of the data synchronization.

2. Description of the Related Art

Recently, portable devices, such as handheld devices, have become more and more technically advanced and multifunctional. For example, a handheld device may receive email messages, have an advanced address book management application, allow media playback, and have various other functions. Because of the conveniences of devices with multiple functions, the devices have become necessities of life.

Mobile devices may be provided with multiple applications or services for users to control functions thereof. Mobile devices may perform a data synchronization procedure to sync with application servers of a number of running applications periodically in order to update and/or exchange data of running applications. Conventionally, data updating of those applications are performed with a fixed update frequency, e.g. updating per hour. Performing data updating with a fixed update frequency, however, may lead to unnecessary sync update since the data synchronization procedure still need to be performed to sync with application servers of the running applications for updating data even if no data is to be updated, thus consuming extra power.

### BRIEF SUMMARY OF THE INVENTION

Data synchronization management methods and systems are provided.

In an embodiment of a data synchronization management method, pluralities of predetermined sync conditions are first set according to time interval information and user behavior information, wherein each of the predetermined sync conditions has a corresponding setting value of update frequency. Then, it is determined whether one of the predetermined sync conditions has been satisfied or a change in the predetermined sync conditions has been detected. In response to one of the predetermined sync conditions being satisfied or a change in the predetermined sync conditions being detected, a data sync procedure is performed with a server to update data from the server based on an update frequency, such that the update frequency of the data sync procedure is dynamically adjusted according to the predetermined sync conditions.

An embodiment of a data synchronization management system for use in an electronic device includes a wireless communication unit and a synchronization unit. The synchronization unit is used for setting a plurality of predetermined sync conditions according to time interval information and user behavior information, determining whether one of the predetermined sync conditions has been satisfied or a change in the predetermined sync conditions has been detected, and in response to one of the predetermined sync conditions being satisfied or a change in the predetermined sync conditions being detected, performing a data sync procedure with a server to update data from the server based on an update frequency via the wireless communication unit, such that the update frequency of the data sync procedure is dynamically adjusted according to the predetermined sync conditions, wherein each of the predetermined sync conditions has a corresponding setting value of update frequency, and the time interval information indicates one of time intervals of a day and the user behavior information comprises application activity information indicating a frequency that an application is being used and/or information device operation status information indicating whether the electronic device is being used.

In another embodiment of a data synchronization management method, pluralities of predetermined sync conditions are first set according to time interval information and user behavior information, wherein each of the predetermined sync conditions has a corresponding setting value of update frequency. It is then determined whether a change in the predetermined sync conditions has been detected. In response to a change in the predetermined sync conditions being detected, it is further determined whether to performing a data sync procedure. In response to the data sync procedure being performed, an update frequency of the data sync procedure is determined based on the time interval information and the user behavior information. The data sync procedure is performed with a server to update data from the server based on the determined update frequency, wherein the update frequency of the data sync procedure is dynamically adjusted according to the predetermined sync conditions, wherein the time interval information indicates one of a plurality of time intervals within a day and the user behavior information comprises application activity information indicating a frequency that an application is being used and/or device operation status information indicating whether the electronic device is being used.

In some embodiments, the determination step further comprises determining whether one of the predetermined sync conditions has been satisfied or a change in the predetermined sync conditions has been detected according to the application activity information.

In some embodiments, the determination step further comprises determining whether one of the predetermined sync conditions has been satisfied or a change in the predetermined sync conditions has been detected according to the device operation status information and the application activity information.

In some embodiments, the device operation status information is determined by using sensors on the electronic device, wherein the sensors at least comprise G-sensor and light sensor.

In some embodiments, the update frequency is adjusted based on the time interval information and the application activity information. In some embodiments, the update frequency is adjusted based on the time interval information and the device operation status information. In some embodiments, the update frequency is adjusted based on the time interval information, the application activity information and the device operation status information.

Data synchronization management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data synchronization management system of the invention;

FIG. 2 is a flowchart of an embodiment of a data synchronization management method of the invention;

FIG. 3 is a schematic diagram illustrating an embodiment of a lookup table according to the invention; and

FIG. 4 is a flowchart of another embodiment of a data synchronization management method of the invention.

### DETAILED DESCRIPTION OF THE INVENTION

Data synchronization management methods and systems are provided.

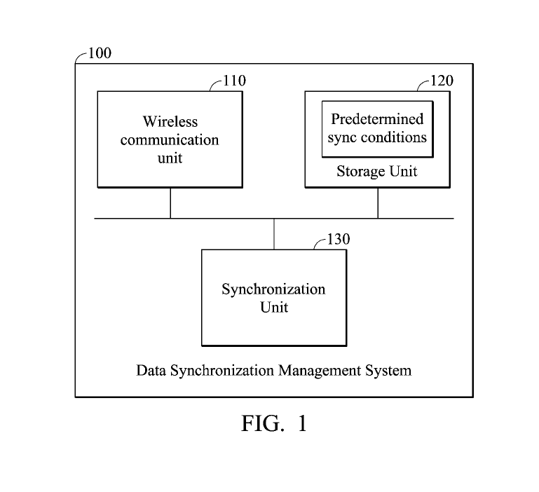

FIG. 1 is a schematic diagram illustrating an embodiment of a data synchronization management system of the invention. The data synchronization management system 100 can be used in an electronic device, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto.

The data synchronization management system 100 at least comprises a wireless communication unit 110, a storage unit 120, and a synchronization unit 130. The wireless communication unit 110 may perform the functionality of wireless transmissions and receptions to and from a number of application servers. To further clarify, the wireless communication unit 110 may comprise a baseband unit (not shown) and a radio frequency (RF) unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the mobile communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the radio access technology (RAT) in use. The synchronization unit 130 may further control the operation of the wireless communication unit 110 and other functional components, such as a display unit and/or keypad serving as the MMI (man-machine interface), the storage unit 120 storing the program codes of applications or communication protocols, or others. The storage unit 120 may be a built-in memory, or an external memory card, which stores related data, such as predetermined sync conditions for data synchronization procedure. It is understood that, the predetermined sync conditions may be stored as a look-up table, state machine, or in other appropriate forms, and specified depending on related factors, such as application activities and operation time intervals. However, it is to be understood that the invention is not limited thereto. The predetermined sync conditions may correspond to time interval information and user behavior information, wherein the time interval information indicates one of a plurality of time intervals within a day and the user behavior information at least comprises application activity information indicating a frequency that an application is being used and/or device operation status information indicating whether the electronic device is being used. For example, the predetermined condition may be set as the application activities is busy for more than 5 minutes and the data sync procedure is performed with the application server in response to the predetermined sync condition that the application activities is busy for more than 5 minutes being satisfied. In another embodiment, the data sync procedure may be set as being performed with the application server per 30 minutes during a time interval from AM 9:00 to PM 5:00.

The synchronization unit 130 can perform the data synchronization management method of the present invention for dynamically adjusting the update frequency of a data sync procedure, which will be discussed further in the following paragraphs.

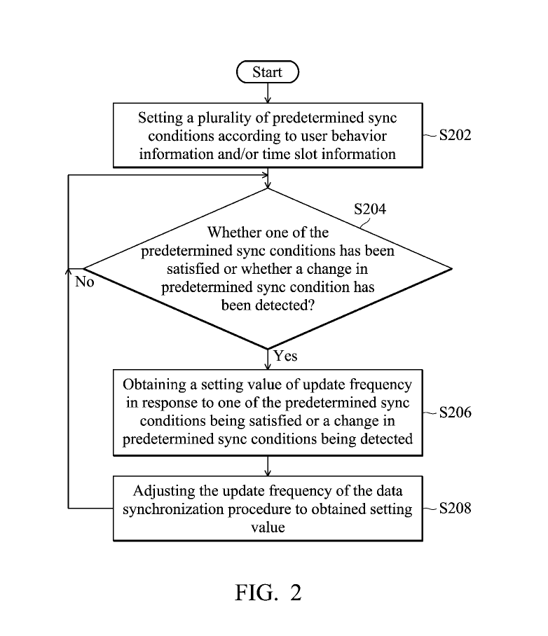

FIG. 2 is a flowchart of an embodiment of a data synchronization management method of the invention. The data synchronization management method can be used for an electronic device, such as a PDA, a smart phone, a mobile phone, an MID, a laptop computer, a car computer, a digital camera, a multi-media player or a game device.

In step S202, pluralities of predetermined sync conditions are first set according to user behavior information and/or time interval information. Each of the predetermined sync conditions may have a corresponding setting value of update frequency for the data sync procedure. It is understood that, in some embodiments, the user behavior information may at least comprise application activity information and device operation status information, but it is not limited thereto. The application activity information of an application indicates that how often the application is being used/checked by the user and the device operation status information indicates that whether the device is being used or not. If the application activity information of an application indicates that the user checks the application often, the update frequency of the data sync procedure of this application becomes shorter; otherwise, the update frequency of the data sync procedure of this application can be extended. For example, if previously setting value of update frequency of the application is set as 30 minutes, the setting value of update frequency of the application can be shortened to a time period less than 30 minutes (e.g. 15 minutes) when the application activity information of an application indicates that the user checks the application often or it may be extended to a hour, a day or longer when the application activity information of an application indicates that the user checks the application rarely. Similarly, if the device operation status information indicates that the device is currently being used, the setting value of update frequency of the application may be set as 5 minutes so that the data sync procedure will be performed within 5 minutes. If the device operation status information indicates that the device is not being used, the setting value of update frequency of the application may be set as extending to next update period so that the data sync procedure will not be performed until next update period has been reached. In some embodiments, the electronic device may further comprise a number of sensors, such as G-sensor, light sensor and so on, and the device operation status information may be determined by using sensor data provided by the sensors. For example, the device may be determined as being used if the sensor data provided by the G-sensor indicates a movement of the device.

After the predetermined sync conditions have been set, in step S204, it is determined that whether any of the predetermined sync conditions has been satisfied or a change in predetermined sync conditions has been detected. It is understood that, in some embodiments, the determination of whether a change in predetermined sync condition has been detected can be performed by detecting whether the time interval information and/or the user behavior information is changed from one predetermined sync condition to another. For example, in one embodiment, when the time interval information indicates that current time is changed from a time interval from AM 1:00 to AM 9:00 to another time interval from AM 9:00 to PM 5:00, it is determined that a change in predetermined sync conditions has been detected.

If no change in the sync conditions has been detected (No in step S204), the procedure returns to step S204 to continually monitor the user behavior and detect whether any of the predetermined sync conditions has been satisfied or whether the predetermined sync condition is changed. In this case, the update frequency is kept unchanged, i.e. the setting value of the update frequency is kept unchanged. If a change in predetermined sync condition has been detected or a specific predetermined sync condition has been satisfied (Yes in step S204), in step S206, a setting value of update frequency is obtained in response to one of the predetermined sync conditions being satisfied or a change in predetermined sync conditions being detected. In some embodiments, the setting value of update frequency can be obtained from a lookup table which is stored in the storage unit 120 and stores the predetermined sync conditions and responsive setting values of update frequency. The setting value of update frequency can be found by table lookup operation based on current user behavior information or status of the electronic device.

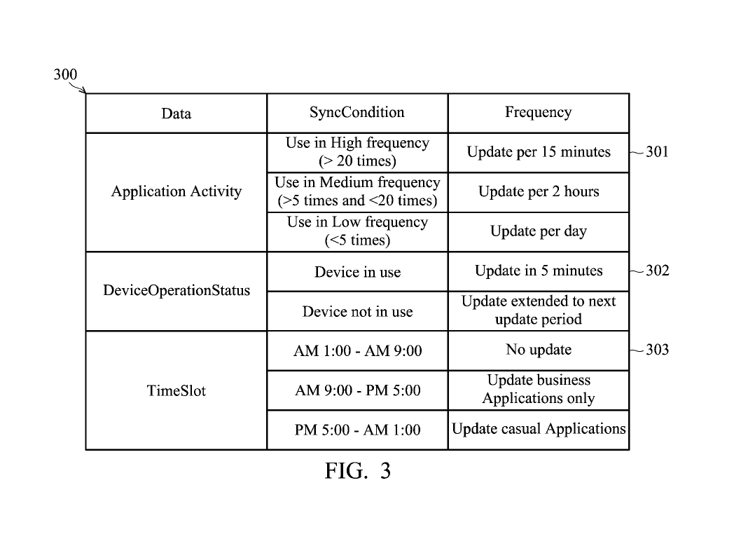

FIG. 3 is a schematic diagram illustrating an embodiment of a lookup table 300 according to the invention. Referring to FIG. 3, the lookup table 300 comprises fields regarding activity data (such as field Data including an item “ApplicationActivity” indicating the application activity information, an item “DeviceOperationStatus” indicating the device operation status information and an item “Timeslot” indicating the time interval information), a sync condition (such as field SyncCondition) and a update frequency data (such as field Frequency), where the field Data represents the user behavior information or the time interval information, the field SyncCondition indicates predetermined conditions for data synchronization and the field Frequency indicates a setting value of the update frequency for the data sync procedure. For example, as shown in FIG. 3, the lookup table 300 comprises records 301, 302, and 303, wherein the fields Data, SyncCondition, and Frequency of the record 301 are set to be “ApplicationActivity”, “Use in High Frequency”, and “15 minutes” respectively, which means that the setting value of update frequency is set to be 15 minutes when the application activity information indicates that the application is used in high frequency (e.g. being used more than 20 times). Therefore, the setting value of update frequency can be obtained from the record 301 when the predetermined sync condition that the application activity information indicating that the application is used in high frequency has been satisfied. Similarly, the fields Data, SyncCondition, and Frequency of the record 303 are set to be “TimeSlot”, “AM 1:00 to AM 9:00”, and “No update” respectively, which means that the data sync procedure will not be performed during the time interval from AM 1:00 to AM 9:00. Therefore, the setting value of update frequency can be obtained from the record 303 when the predetermined sync condition that the time interval information indicating that it is within the time interval from AM 1:00 to AM 9:00 has been satisfied.

After the setting value of update frequency has been obtained, in step S208, the update frequency of the data sync procedure is adjusted to the obtained setting value of update frequency. Therefore, the data sync procedure will be performed based on the adjusted update frequency. For example, if the data sync procedure is set to be performed with an update frequency of 30 minutes, it may be performed with an update frequency of 15 minutes or 1 hour in response to one of the sync conditions being satisfied or a change in sync conditions being detected.

The synchronization unit 130 may then issue a sync request to an application server (not shown) wirelessly via the wireless communication unit 110 to perform the data sync procedure with the application server using the new update frequency for updating data. The application server may store data to be updated in a database. Upon reception of a sync request, the application server determines the identity of the requesting device and retrieves requested data from the database. When the requested data is retrieved from the database, the application server sends back the update data to the requesting device. Upon reception of the updated data from the application server via the wireless communication unit 110, the synchronization unit 130 may transmit the data to the responsive application.

In one embodiment, the update frequency may be adjusted based on the time interval information and/or the application activity information. That is, the update frequency may be adjusted to different values depending on whether the application activity information indicating that the application is being used in high, medium or low frequency and when the application is being used. For example, the setting value of update frequency of a business application may first be adjusted to be 15 minutes if the application activity information indicates that the application is being used in high frequency and then be adjusted to be 2 hours if the application activity information indicates that the application is changed from being used in high frequency to in low frequency.

In another embodiment, the update frequency may be adjusted based on the time interval information and the device operation status information. That is, the update frequency may be adjusted to different values depending on whether the application activity information indicating that the application is being used in high, medium or low frequency and whether the device operation status information indicating that the device is being used. For example, the setting value of update frequency of a non-business application may be adjusted to be 5 minutes if the device operation status information indicates that the application is being used and the time interval information indicates that the application is being used during the time interval from PM 5:00 to AM 1:00 while it may not be changed if the device operation status information indicates that the application is being used and the time interval information indicates that the application is being used during the time interval from AM 9:00 to PM 5:00.

In another embodiment, the update frequency may be adjusted based on the time interval information, the application activity information and the device operation status information. That is, the update frequency may be adjusted to different values depending on whether the application activity information indicating that the application is being used is high, medium or low frequency and whether the device operation status information indicating that the device is being used and when the application is being used. For example, referring to FIG. 3, the setting value of update frequency of a business application may first be adjusted to be 15 minutes if the application activity information indicates that the application is being used in high frequency, the device operation status information indicates that the device is being used and the time interval information indicates that the application is being used during the time interval from AM 9:00 to PM 5:00. The setting value of update frequency of this business application may then be adjusted to be a day if the application activity information indicates that the application is changed from being used in high frequency to in low frequency during the same time interval from AM 9:00 to PM 5:00.

In some embodiments, it is further determined whether to adjust the update frequency of the data sync procedure based on the application activity information, the device operation status information and/or the time interval information prior to performing the data sync procedure.

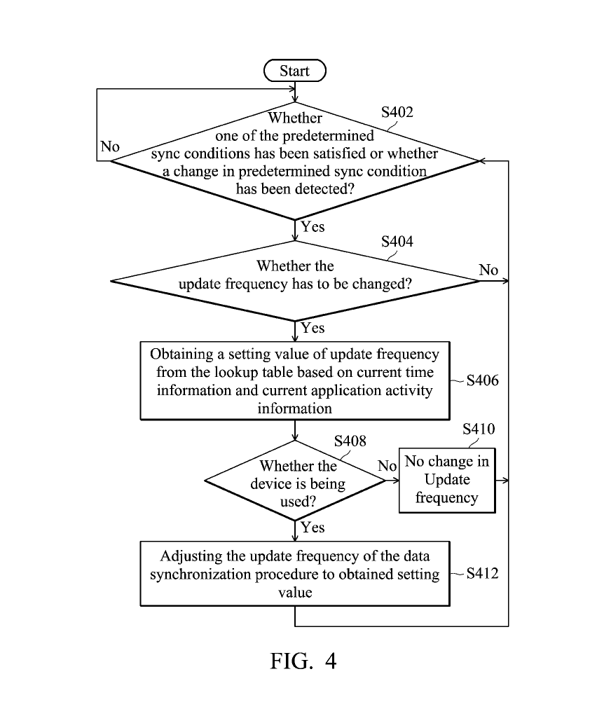

FIG. 4 is a flowchart of another embodiment of a data synchronization management method of the invention. The data synchronization management method can be used for an electronic device, such as a PDA, a smart phone, a mobile phone, an MID, a laptop computer, a car computer, a digital camera, a multi-media player or a game device. In this embodiment, assume that a plurality of sync conditions have been set in a lookup table (e.g. the lookup table 300 of FIG. 3) according to user behavior information and/or time interval information. It is understood that, as mentioned above, the user behavior information may at least comprise the application activity information and the device operation status information, but it is not limited thereto. The application activity information of an application indicates that how often the application is being used/checked by the user and the device operation status information indicates that whether the device is being used or not.

In step S402, it is determined that whether any of the predetermined sync conditions has been satisfied or a change in predetermined sync conditions has been detected. It is understood that, in some embodiments, the determination of whether a change in predetermined sync condition has been detected can be performed by detecting whether the time interval information and/or the user behavior information is changed from one sync condition to another.

If no change in the sync conditions has been detected (No in step S402), the procedure returns to step S402 to continually monitor the user behavior and detect whether any of the predetermined sync conditions has been satisfied or whether the sync condition is changed. In this case, the update frequency is kept unchanged. If a change in sync condition has been detected or a specific sync condition has been satisfied (Yes in step S402), in step S404, it is further determined whether the update frequency has to be changed. The determination of whether the update frequency has to be changed or not can be performed by a table lookup operation with a lookup table (e.g. the lookup table 300 shown in FIG. 3) based on current user behavior information or status of the electronic device.

If the update frequency is determined as being changed (Yes in step S404), in step S406, a new setting value of update frequency is obtained from a lookup table. Thereafter, in step S408, it is further determined whether the device is being used. If the device is not being used (No in step S408), in step S410, the update frequency is kept unchanged and the procedure returns to step S402. If the device is being used (Yes in step S408), in step S412, the update frequency is changed to the new value and the procedure returns to step S402.

In some embodiments, the electronic device may further include a GPS receiver (not shown) and the update frequency may be adjusted based on location information provided by the GPS receiver. The GPS receiver may receive GPS satellite signals and the location information of the electronic device may be obtained based on the received signals. The synchronization unit 130 may first determine the location of the electronic device based on the location information and then adjust the update frequency accordingly. For example, no data sync procedure will be performed if the electronic device is located abroad or the update frequency of the data sync procedure may be dynamically adjusted to a shorter period to quickly update data for the user if the electronic device is moved to the home from the office.

In summary, the data synchronization management methods and systems of the invention can adaptively adjust the data update frequency of applications or services based on different sync conditions according to predetermined sync settings such that data sync procedure can be performed efficiently based on the current activities or status of the mobile device, thus saving power and resulting in a better battery life.

Data synchronization management methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data synchronization management method for use in an electronic device, comprising:
setting a plurality of predetermined sync conditions according to time interval information and user behavior information, wherein each of the predetermined sync conditions has a corresponding setting value of update frequency;
determining whether one of the predetermined sync conditions has been satisfied or a change in the predetermined sync conditions has been detected; and
in response to one of the predetermined sync conditions being satisfied or a change in the predetermined sync conditions being detected, performing a data sync procedure with a server to update data from the server based on an update frequency,
wherein the time interval information indicates one of a plurality of time intervals within a day and the user behavior information comprises application activity information indicating a frequency that an application is being used and/or device operation status information indicating whether the electronic device is being used.

2. The method of claim 1, wherein the determination step further comprises determining whether one of the predetermined sync conditions has been satisfied or a change in the predetermined sync conditions has been detected according to the application activity information.

3. The method of claim 1, wherein the determination step further comprises determining whether one of the predetermined sync conditions has been satisfied or a change in the predetermined sync conditions has been detected according to the device operation status information and the application activity information.

4. The method of claim 1, wherein the device operation status information is determined by using sensors on the electronic device, wherein the sensors at least comprise G-sensor and light sensor.

5. The method of claim 1, wherein the determination step further comprises determining whether one of the predetermined sync conditions has been satisfied or a change in the predetermined sync conditions has been detected according to the device operation status information, the application activity information and the time interval information.

6. The method of claim 1, wherein the update frequency is dynamically adjusted according to location information provided by a GPS receiver.

7. The method of claim 1, further comprising determining whether to adjust the update frequency of the data sync procedure based on the application activity information, the device operation status information and/or the time interval prior to performing the data sync procedure.

8. The method of claim 7, further comprising:
in the step of determining of the predetermined sync conditions, obtaining a setting value of update frequency to adjust to from the setting values of update frequency corresponding to the predetermined sync conditions based on the application activity information, the device operation status information and/or the time interval; and
adjusting the update frequency of the data sync procedure to the obtained setting value of update frequency.

9. The method of claim 8, wherein the predetermined sync conditions and the corresponding setting values of update frequency of the predetermined sync conditions are stored on a lookup table and the setting value of update frequency to adjust to is obtained from the lookup table by a table lookup operation.

10. The method of claim 8, wherein the update frequency of the data sync procedure is determined as not being adjusted in response to the device operation status indicates that the electronic device is not being used.

11. A data synchronization management system for use in an electronic device, comprising:
a wireless communication unit; and
a synchronization unit for setting a plurality of predetermined sync conditions according to time interval information and user behavior information, determining whether one of the predetermined sync conditions has been satisfied or a change in the predetermined sync conditions has been detected, and in response to one of the predetermined sync conditions being satisfied or a change in the predetermined sync conditions being detected, performing a data sync procedure with a server to update data from the server based on an update frequency via the wireless communication unit, such that the update frequency of the data sync procedure is dynamically adjusted according to the predetermined sync conditions,
wherein each of the predetermined sync conditions has a corresponding setting value of update frequency, and the time interval information indicates one of a plurality of time intervals within a day and the user behavior information comprises application activity information indicating a frequency that an application is being used and/or information device operation status information indicating whether the electronic device is being used.

12. The system of claim 11, wherein the synchronization unit further determines whether one of the predetermined sync conditions has been satisfied according to the application activity information.

13. The system of claim 11, wherein the synchronization unit further determines whether one of the predetermined sync conditions has been satisfied according to the device operation status information and the application activity information.

14. The system of claim 11, wherein the device operation status information is determined by using sensors on the electronic device, wherein the sensors at least comprise G-sensor and light sensor.

15. The system of claim 11, wherein the synchronization unit further determines whether one of the predetermined sync conditions has been satisfied according to the device operation status information, the application activity information and the time interval information.

16. The system of claim 11, wherein the update frequency is dynamically adjusted according to location information provided by a GPS receiver.

17. The system of claim 11, wherein the synchronization unit further determines whether to adjust the update frequency of the data sync procedure based on the application activity information, the device operation status information and/or the time interval prior to performing the data sync procedure.

18. The system of claim 17, wherein when determining to adjust the update frequency of the data sync procedure, the synchronization unit further obtains a setting value of update frequency to adjust to from the setting values of update frequency corresponding to the predetermined sync conditions based on the application activity information, the device operation status information and/or the time interval; and adjusts the update frequency of the data sync procedure to the obtained setting value of update frequency.

19. The system of claim 18, wherein the predetermined sync conditions and the corresponding setting values of update frequency of the predetermined sync conditions are stored on a lookup table and the setting value of update frequency to adjust to is obtained from the lookup table by a table lookup operation.

20. A data synchronization management method for use in an electronic device, comprising:
setting a plurality of predetermined sync conditions according to time interval information and user behavior information, wherein each of the predetermined sync conditions has a corresponding setting value of update frequency;
determining whether a change in the predetermined sync conditions has been detected;
in response to a change in the predetermined sync conditions being detected, determining whether to performing a data sync procedure;
in response to the data sync procedure being performed, determining an update frequency of the data sync procedure based on the time interval information and the user behavior information; and
performing the data sync procedure with a server to update data from the server based on the determined update frequency,
wherein the update frequency of the data sync procedure is dynamically adjusted according to the predetermined sync conditions,
wherein the time interval information indicates one of time intervals of a day and the user behavior information comprises application activity information indicating a frequency that an application is being used and/or device operation status information indicating whether the electronic device is being used.
